(19) United States
(12) Patent Application Publication
(10) Pub. No.: US 2014/0196402 A1
(43) Pub. Date: Jul. 17, 2014

(54) DEVICE FOR INSERTING DISTANCING CORDS

(71) Applicant: LISEC AUSTRIA GMBH, Seitenstetten (AT)

(72) Inventors: Leopold Mader, Neuhofen/Ybbs (AT); Erich Lang, Greinsfurth (AT); Alexander Kronsteiner, Blindenmarkt (AT)

(73) Assignee: LISEC AUSTRIA GMBH, Seitenstetten (AT)

(21) Appl. No.: 14/233,161

(22) PCT Filed: Sep. 20, 2012
(86) PCT No.: PCT/AT2012/000240

§ 371 Date: Jan. 16, 2014

(30) Foreign Application Priority Data
Sep. 22, 2011 (AT) A 1372/2011

(51) Int. Cl. B65G 49/06

(52) U.S. Cl. CPC B65G 49/068
USPC 53/139.4

(57) ABSTRACT

In order to insert at least two zick-zack-extending cords (1) between two adjacent glass panels (2, 3, 4), in order to maintain the glass panels (2, 3, 4) at a distance from each other, cord guiding heads (20) which can be moved up and down on the front side of the front glass panel (2, 3) are provided. In order to move each guide head up and down, a length of the cord is placed on the glass panel for each guiding head. Gripping elements (14) are provided in the region of the lower edge of the glass panel, to maintain the cords (1) by forming loops (5) which are provided below the lower edge of the glass panels (2, 3, 4), the guiding heads (20) being displaced along the glass panels (2, 3, 4) up and down again and forming another length of cord (1).

The invention relates to a device with the features of the introductory part of claim 1.

In order to keep glass panels (flat glass or insulating glass) separated from one another when being laid down on bearing blocks, i.e., in order to prevent the glass panels from resting flat on one another, it is known to apply small cork plates distributed over the surfaces of the glass panels.

This is a cumbersome and expensive matter both when mounting and removing the small cork plates and also has the result that the danger exists that adhesive residues will remain on the glass panel when the small cork plates are removed again.

For attaching small cork plates, automated devices have also become known, in which connection reference can be made to AT 390 431 B (=EP 0 334 832 A).

It is also known to insert cords between glass panels so that glass panels are kept separated from one another by the inserted cords.

In this known manner, to keep glass panels separated from one another by cords attached between the latter, the cords are placed around the upper edges of the glass panels and are guided upward again after a loop is formed below the lower edges of the glass panels, whereupon then the next glass panel can be applied, and the cord can be placed upward again around the newly applied glass panel and can be guided upward again after a loop is formed below the lower edge. Depending on the size of the glass panel, it is also known to insert two or more cords beside one another as distancing means.

The object of the invention is to propose a device with which the insertion of cords as distancing means between glass panels can be done easily and quickly, in particular in a fully automated manner.

This object is achieved with a device that has the features of claim 1. Preferred and advantageous configurations of the invention are subjects of the subclaims.

Since, in the device according to the invention in an exemplary embodiment for guiding cords (at least two cords), a beam with cord guides is provided—whereby the beam is moved downward along a glass panel that leans against a support frame, and grippers are provided on the lower edge, which grip the cord in the loop area below the lower edges of the glass panels and hold it until the next glass panel has been placed on the cord after the upward movement of the beam with the cord guides—a cord in two lengths is inserted between two adjoining glass panels in a simpler way, so that a safe distancing of the glass panels is achieved.

Because of the device according to the invention, the possibility exists of handling the cords in such a way that the latter are tensioned. This can be done in particular by the grippers that are provided on the lower edge of the glass panels.

In one embodiment, the device according to the invention can be distinguished, for example, by the gripper having two angled levers.

In one embodiment, the device according to the invention can be distinguished, for example, by the gripper having a drive for opening and closing.

In one embodiment, the device according to the invention can be distinguished, for example, by the lever of the gripper being pivotable, in particular by the drive, around axes that are oriented essentially parallel to the plane of the objects.

In one embodiment, the device according to the invention can be distinguished, for example, by the free ends of the lever being formed minor-inverted.

In one embodiment, the device according to the invention can be distinguished, for example, by one lever on its free end having a projection that is in particular cone-shaped and by the other lever on its free end having a recess that is formed mirror-inverted to the projection.

In one embodiment, the device according to the invention can be distinguished, for example, by at least one guiding head being provided and by the guiding head being adjustable in a plane parallel to the objects from a starting position up to the gripper.

In one embodiment, the device according to the invention can be distinguished, for example, by the guiding head having a cord guide, which cord is fed from a cord reel.

In one embodiment, the device according to the invention can be distinguished, for example, by the guiding head having a deflecting part, around which the cord is guided.

In one embodiment, the device according to the invention can be distinguished, for example, by the gripper being able to be switched from a readiness position into an operative position, in which its levers are arranged engaging in the loop of the cord, held by the deflecting part, adjacent to one edge of the objects [sic].

In one embodiment, the device according to the invention can be distinguished, for example, by the guiding head being arranged on a beam and by the beam being guided to move over slots on guides parallel to the objects.

In one embodiment, the device according to the invention can be distinguished, for example, by the deflecting part being fastened via a rod on the beam.

In one embodiment, the device according to the invention can be distinguished, for example, by the deflecting part having a bent deflecting rod.

In one embodiment, the device according to the invention can be distinguished, for example, by the bent-hollow side of the deflecting rod being oriented pointing away from the beam.

In one embodiment, the device according to the invention can be distinguished, for example, by a support wall being provided, on which objects lean that are to be laid against a support frame, which is arranged opposite to the support wall, and by at least one conveying device, in particular a conveyor belt, being provided for hauling the objects on the lower edge of the support wall.

In one embodiment, the device according to the invention can be distinguished, for example, by a reversing device—equipped in particular with at least one suction head—being provided in the support wall, and by the reversing device being able to be switched between a readiness position within the support wall and a release position brought toward the support frame.

In one embodiment, the device according to the invention can be distinguished, for example, by the guides for the beam being arranged with the guiding head between the support wall and the support frame.

In one embodiment, the device according to the invention can be distinguished, for example, by the support frame being guided to move crosswise with respect to the support wall via slots on rails.

In one embodiment, the device according to the invention can be distinguished, for example, by at least one gripper in the area of the lower edge of the support wall being able to be adjusted relative to the latter and being able to be adjusted back and forth crosswise with respect to the surface of the same.

In one embodiment, the device according to the invention can be distinguished, for example, by two or more than two grippers being provided and by a guiding head being assigned to each gripper.

In one embodiment, the device according to the invention can be distinguished, for example, by the support wall and the support frame being tilted in opposite directions with respect to the vertical and by the distance between the support wall and support frame being smaller below than above.

It is also advantageous in the device according to the invention that the cords, unlike in the device known from DE 2 309 123 A, where the cords are placed around the lower edges of the glass panels, are arranged between one and the same glass panels both in their area leading downward and in their section leading upward from the loops (below the glass panels and suspended in a plane between the glass panels).

Additional details and features of the invention follow from the description below of a preferred embodiment based on the drawings. Here:

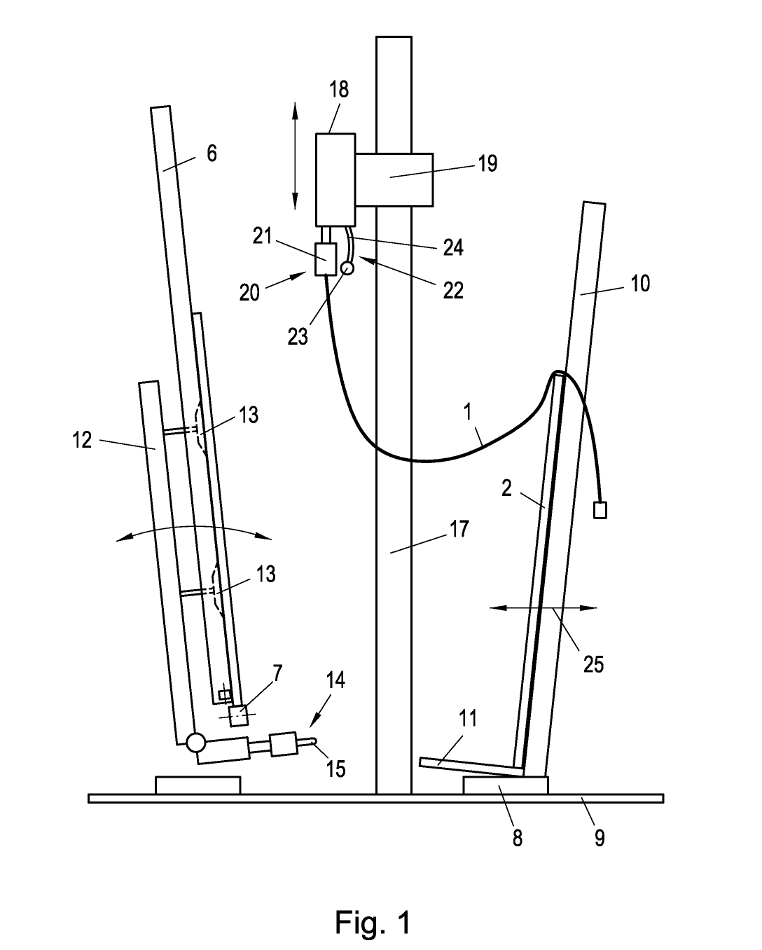

FIG. 1 diagrammatically shows a device according to the invention in side view,

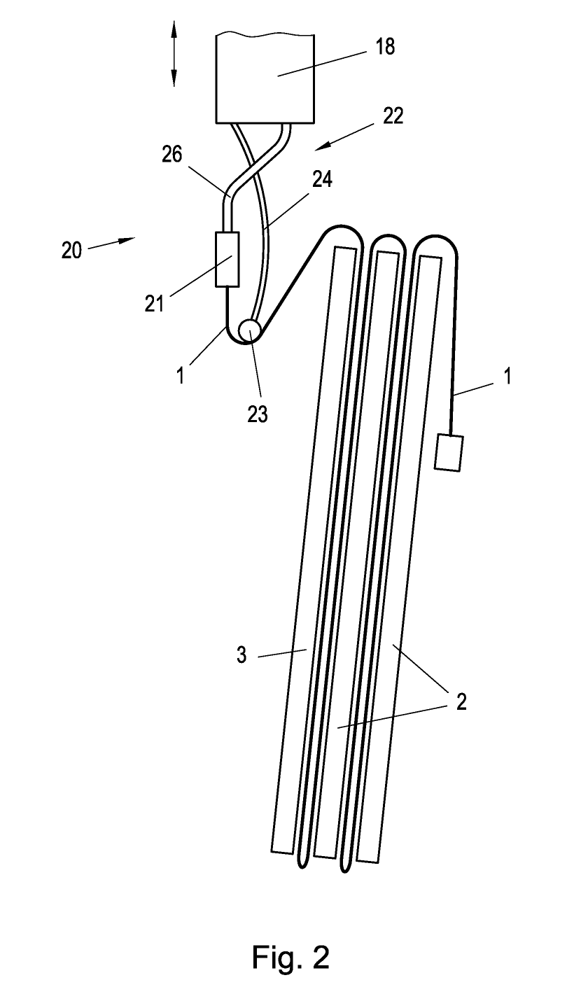

FIG. 2 shows, on an enlarged scale, a detail in the area of the cord guide that is provided on the beam,

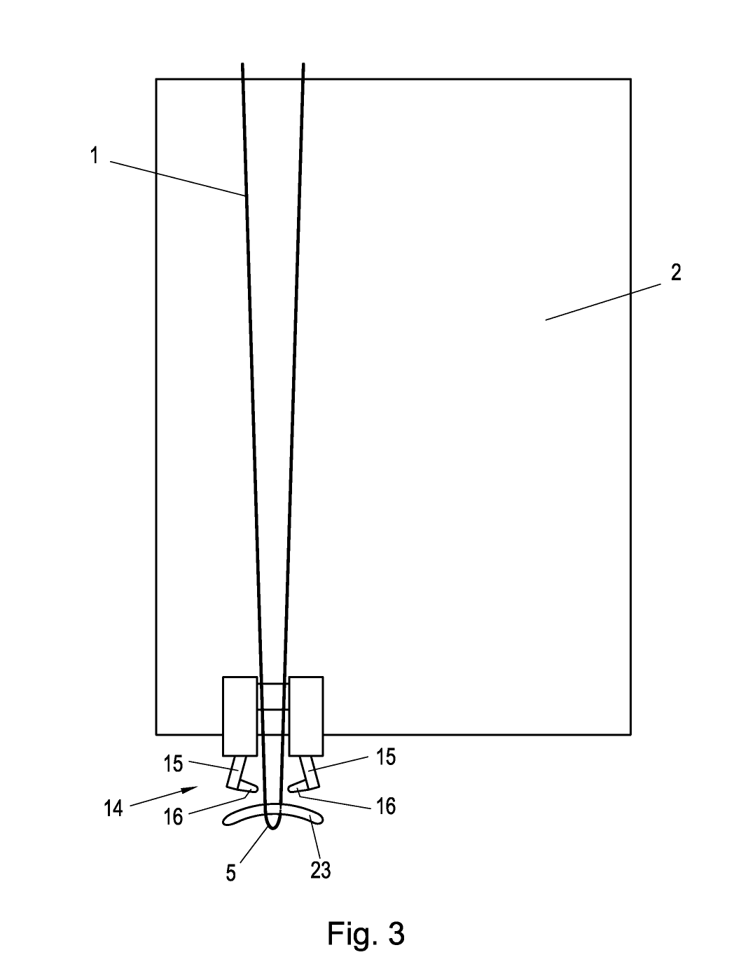

FIG. 3 shows, viewed from the front, the gripper for temporary holding of the loop on the lower edge of the glass panels,

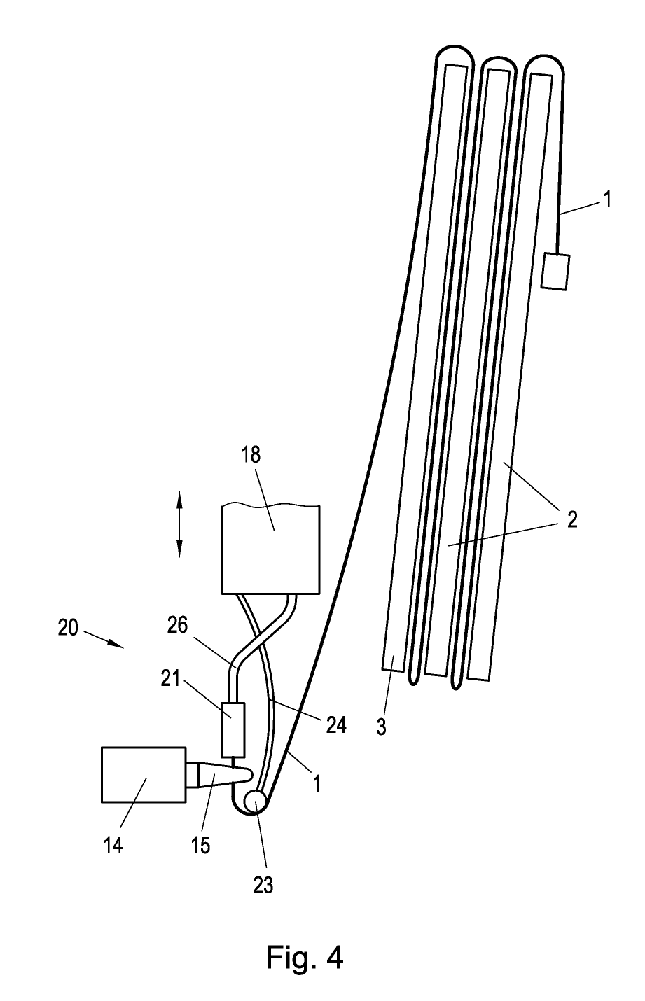

FIG. 4 shows a side view for this with assigned cord guide, and

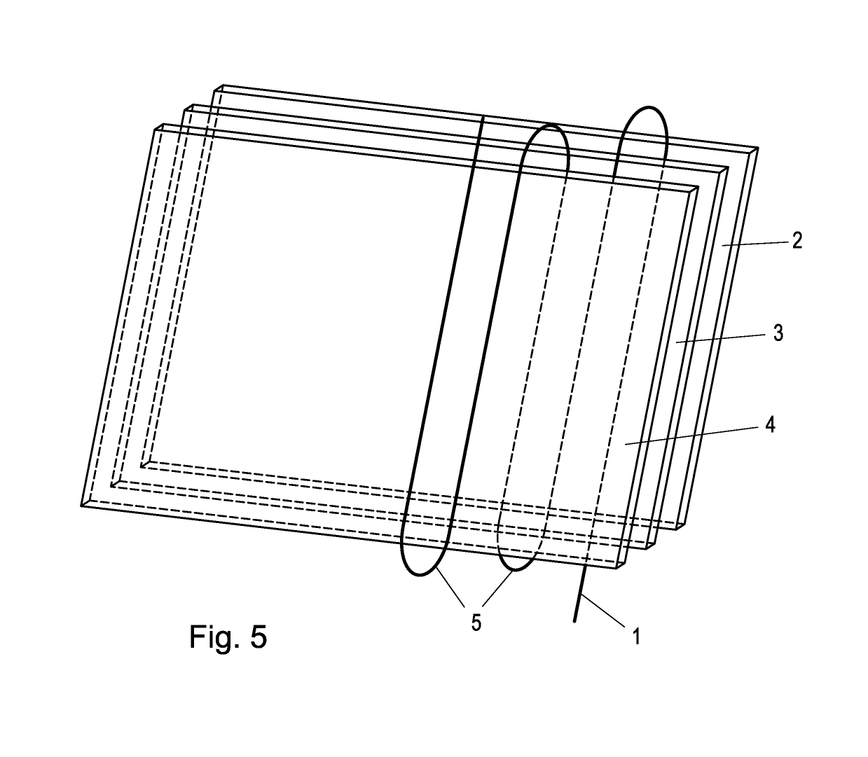

FIG. 5 shows, in schematic form, a packet that consists of three glass panels with cords inserted in-between as distancing means.

The purpose of the device according to the invention is to provide at least one cord 1, but preferably two or more cords, as is indicated in schematic form in FIG. 5, between glass panels 2, 3, 4 that lean on one another and that are arranged parallel to one another. In this case, it is provided that the cord 1 is guided downward from the rearmost glass panel 2 in FIG. 5 from the upper edge around which it is placed, forms a loop 5 lying below the lower edge of the glass panel 2 at the bottom, and is guided upward again. The cord 1 is then further placed around the upper edge of a second (middle in the example of FIG. 5) glass panel 3 applied on the cord before the first glass panel 2 and guided downward again before the second glass panel 3 and formed into a loop 5 at the bottom. Then, the cord 1 is guided upward again and then placed around the upper edge of a third (foremost) glass panel 4 laid before the second glass panel 3, guided downward, and guided upward again with the formation of a loop 5. Thus, a reliable distancing of the glass panels 2, 3, 4 from one another is achieved by the cord 1, whereby when unstacking the glass panels 2, 3, 4, it is sufficient simply to remove the cord 1 (for example to wind it up or the like), and there is no risk that adhesive residues (of small cork plates) will remain on the glass panels 2, 3, 4. It is understood that depending on the size of the glass panels 2, 3, 4, two or more than two cords 1, as previously described based on FIG. 5, can be arranged distributed over the surfaces (width) of the glass panels 2, 3, 4.

The device according to the invention that is provided in particular with two or more cords 1, for inserting at least one cord 1, comprises a support wall 6, mounted in a machine frame, on which frame glass panels 2 are hauled, in leaning fashion, via a conveying system, e.g., a conveyor belt 7. This is carried out crosswise to the image plane of FIG. 1.

The support wall 6 for the conveying of glass panels 2 opposite is provided on a slot 8, movable on rails 9, a frame 10 for laying down glass panels 2 with the formation of stacks [sic]. FIG. 1 shows that the support wall 6 for the conveying of glass panels 2 is tilted in one direction (approximately 5°) with respect to the vertical; conversely, the frame 10 is oriented tilted in the other direction (approximately 5°) with respect to the vertical for the placing of glass panels 2 in the form of a stack. Glass panels 2 leaning on the frame 10 are placed below on support arms 11.

In the support wall 6, a reversing device 12 is provided, which can be moved forward from the support wall 6 in the direction toward the frame 10—brought toward the support wall 6—in order to lay a glass panel on the frame 10.

The reversing device 12 preferably has several suction heads 13 in order to hold a glass panel 2 that is to be laid on the frame 10, while it is moved away from the support wall 6 toward the frame 10 (reversed).

In the area of the lower edge of the support wall 6, in particular below the conveyor belt 7, grippers 14 are provided, which are used to hold temporarily loops 5 of the cord 1 formed below the lower edge of glass panels 2 laid on the frame 10. The grippers 14 have (cf. FIG. 3), for example, two L-shaped levers 15 that can be pivoted in such a way that they can be pivoted from the “open” position shown in FIG. 3 into a “closed” position, in which the free ends of their guides 16 adjoin one another.

In this case, the free ends of the guides 16 can be designed mirror-inverted (projection-recess). Drives (not shown) are provided for pivoting the levers 15.

Between the support wall 6 for conveying glass panels 2 and the frame 10 for the de-stacking of glass panels 2, a horizontally-oriented beam 18 guided over slots 19 on two guides 17 is provided. For adjusting the beam 18 along the guides 17, which are at least essentially parallel to the support plane of the support frame 10, drives, not shown in more detail (chains, toothed belts), are provided.

On the beam 18, a guiding head 20 is provided for each of the cords 1 to be inserted. Each guiding head 20 comprises a cord guide 21 with an outlet directed downward, from which the cord 1 exits. Cord 1 from a reel (cord pulley) is fed to each cord guide 21.

The guiding heads 20 also comprise deflecting parts 22 arranged beside the cord guides 21, which parts have a bent deflecting rod 23 (curved, with the hollow side pointing downward), which is fastened on the beam 18 via a rod 24.

When using the device according to the invention, the frame 10 is brought toward the support wall 6 for the laying of glass panels 2 by being pushed in the direction of the double arrow 25 to the support wall 6. Then, a glass panel 2 is laid on the frame 10 using the reversing device 12 with at least two suction heads 13. As soon as the reversing device 12 has been moved back again into the support wall 6, the beam 18, on which at least one guiding head 20, but preferably two or more than two guiding heads 20, is/are provided, is moved downward, whereby one cord 1 per guiding head 20 is placed on the side near to the support wall 6 of a glass panel 2 leaning on the frame 10. The free end of the cord 1 is fastened in advance to a part of the frame 10, which lies behind the glass panel 2, e.g., is simply knotted thereto.

It is evident in particular from FIG. 2 that a pipe 26 runs to the cord guide 21 of the guiding head 20, through which a cord 1 is fed from a cord reel (cord spool or the like) laid, for example, beside the device. The cord 1 exits from the cord guide 21 through its outlet (downward). In addition to the outlet of the cord guide 21, the deflecting part 22 is provided, around which, as can be seen in FIG. 2, the cord 1 is guided. By downward movement of the beam 18 with the guiding head 20 and the deflecting part 22, a length of cord is placed over the upper edge of a glass panel 2 and guided downward to below the lower edge of the glass panel 2. As soon as the beam 18 with the guiding head 20 has been moved downward so that the deflecting part 22 for the cord 1 is below the lower edge of the glass panel 2, the gripper 14 is moved forward from its readiness position below the support wall 6, and the L-shaped lever 15, engaging in the loop 5 formed between the cord guide 21 and the deflecting part 22, is closed (FIGS. 3, 4), so that they hold the loops 5, while the beam 18 is moved upward again with the guiding head 20, whereby a length of cord 1 that runs upward along the front side of the glass panel 2 is formed.

As soon as the beam 18 with the guiding head 20 has reached the upper end position, a new glass panel 3, which has in the meantime been brought leaning on the support wall 6, is placed on the glass panel 2 that is on the frame 10 and in this case distanced by the two lengths of the cord 1 from the underlying glass panel 2. As soon as this has taken place, the gripper 14, which has previously held the loops 5, is opened, lets the loops 5 go, and is moved back into its readiness position below the conveying system 7 on the support wall 6.

As soon as a new glass panel 3 has been applied, the beam 18 is moved downward again with the cord guide 20, whereby the cord 1 is placed around the upper edge of the newly laid-down glass panel 3, and then, as previously described, a loop 5 formed on the lower end is held using the gripper 14. Then, the beam 18 is moved upward again with the guiding head 20, so that ultimately two sections of cord 1 are formed on the front side of the glass panel 3. This is continued until a packet that consists of the desired number of glass panels 2, 3, 4 (flat glass or insulating glass) is formed and can be removed from the device (support frame 10) for further development or processing.

It is advantageous in the device according to the invention that on the guiding head 20 viewed from the cord guide 21, from which the cord exits through the outlet thereof and the deflecting part 22, which is fastened via a rod 24 (bracket) on the beam 18 and has a concave deflecting rod 23 viewed from below, no devices at all are necessary to hold a cord 1 temporarily, since the cord 1 is held during downward movement of the guiding head 20 between the two glass panels 2, 3 already leaning on the frame 10 and during upward movement of the guiding head 20 by the gripper 14.

In summary, an embodiment of the invention can be described as follows:

In order to insert at least two zigzagging cords 1 between two adjacent glass panels 2, 3, 4 to keep the glass panels 2, 3, 4 at a distance from one another, guiding heads 20 for cords 1 are provided, which can be moved back and forth on the front side of the foremost glass panel 2, 3. By moving guiding heads 20 from the top to the bottom, each guiding head 20 is placed one length of cord 1 on the glass panel 2, 3, 4. In the area of the lower edge of the glass panels, grippers 14 are provided, which hold the cords 1 while loops 5 are formed, which are provided below the lower edge of the glass panels 2, 3, 4, while the guiding heads 20 are moved upward again along the glass panels 2, 3, 4 and form an additional length of cord 1.

1. Device for inserting at least one cord (1) between flat objects, such as glass panels (2, 3, 4), whereby the cord (1) forms a loop (5) on one edge of the objects (2, 3, 4), characterized in that at least one gripper (14) for temporary holding of the cord (1) in the area of the loop (5) is assigned to one edge of the objects (2, 3, 4).

2. Device according to claim 1, wherein the gripper (14) has two bent levers (15).

3. Device according to claim 1, wherein the gripper (14) has a drive for opening and closing.

4. Device according to claim 2, wherein the lever (15) of the gripper (14) can be pivoted, in particular by the drive, around axes that are oriented essentially parallel to the plane of the objects (2, 3, 4).

5. Device according to claim 2, wherein the free ends of the lever (15) are formed mirror-inverted.

6. Device according to claim 5, wherein the one lever (15) on its free end has an especially cone-shaped projection and the other lever (15) on its free end has a recess formed mirror-inverted to the projection.

7. Device according to claim 1, wherein at least one guiding head (20) is provided and wherein the guiding head (20) is adjustable in a plane parallel to the objects (2, 3, 4) from a starting position up to the gripper (14).

8. Device according to claim 7, wherein the guiding head (20) has a cord guide (21), which cord (1) is fed from a cord reel.

9. Device according to claim 7, wherein the guiding head (20) has a deflecting part (22) around which the cord (1) is guided.

10. Device according to claim 9, wherein the gripper (14) can be switched from a readiness position into an operative position, in which its levers (15) are arranged engaging in the loop (5) of the cord (1), held by the deflecting part (22), in addition to one edge of the objects (2, 3, 4).

11. Device according to claim 7, wherein the guiding head (20) is arranged on a beam (18) and wherein the beam (18) is guided to move over slots (19) on guides (17) parallel to the objects (2, 3, 4).

12. Device according to claim 9, wherein the deflecting part (22) is fastened via a rod (24) on the beam (18).

13. Device according to claim 9, wherein the deflecting part (22) has a bent deflecting rod (23).

14. Device according to claim 13, wherein the bent-hollow side of the deflecting rod (23) is oriented pointing away from the beam (18).

15. Device according to claim 1, wherein a support wall (6) is provided, on which objects (2, 3, 4) lean that are to be laid against a support frame (10), which is arranged opposite to the support wall (6), and wherein at least one conveying system, in particular a conveyor belt (7), is provided for hauling the objects (2, 3, 4) on the lower edge of the support wall (6).

16. Device according to claim 15, wherein a reversing device (12)—equipped in particular with at least one suction head (13)—is provided in the support wall (6), and wherein the reversing device (12) can be switched between a readiness position within the support wall (6) and a release position brought toward the support frame (10).

17. Device according to claim 15, wherein the guides (17) for the beams (18) are arranged with the guiding head (20) between the support wall (6) and the support frame (10).

18. Device according to claim 15, wherein the support frame (10) is guided to move crosswise with respect to the support wall (6) via slots (8) on rails (9).

19. Device according to claim 15, wherein the at least one gripper (14) in the area of the lower edge of the support wall (6) is able to be adjusted relative to the latter and is able to be adjusted back and forth crosswise with respect to the surface of the same.

20. Device according to claim 1, wherein two or more than two grippers (14) are provided and wherein a guiding head (20) is assigned to each gripper (14).

21. Device according to claim 15, wherein the support wall (6) and the support frame (10) are tilted in opposite directions with respect to the vertical and wherein the distance between the support wall (6) and the support frame (10) is smaller below than above.
